(19) United States
(12) Patent Application Publication
(10) Pub. No.: US 2023/0133279 A1
(43) Pub. Date: May 4, 2023

(54) ELECTRICAL POWER COUPLING

(71) Applicant: Group Dekko, Inc., Fort Wayne, IN (US)

(72) Inventors: Raymond H. Riner, Fort Wayne, IN (US); Brian K. Rupert, Kendallville, IN (US)

(73) Assignee: Group Dekko, Inc., Fort Wayne, IN (US)

(21) Appl. No.: 17/453,545

(22) Filed: Nov. 4, 2021

(51) Int. Cl. H02G 3/04; H02G 3/34

(52) U.S. Cl. CPC H02G 3/0406; H02G 3/34; H01R 25/006

(57) ABSTRACT

An electrical power coupler for installation in a tower pedestal table, the tower pedestal table having a column extending up from a base. The electrical power coupler including a generally cylindrical shaped structural member that is insertable into an end of the column. There is at least one channel along a side of the structural member, and the at least one channel has an obstructed end. A power conduit extends through the structural member.

### BACKGROUND OF THE INVENTION

### 1. Field of the Invention

The present invention relates to an electrical power coupling in a tower tray system.

### 2. Description of the Related Art

An electrical power cord or appliance coupler generally has a retaining clamp used to secure the electrical power cord to the appliance or an electrical connection enclosure. The retaining clamp is a mechanical device that prevents the electrical power cord from inadvertently being pulled or shaken loose.

In North America, the National Electrical Manufacturers Association develops standards for electrical plugs, receptacles, electrical cables, and clamping requirements.

In public areas, such as parks, a pedestal table can be provided having a single column support that is embedded in the ground, or in a suitable ballast to prevent movement, with a tabletop mounted to the top of the single column. A movable version is often used in reception areas in the form of small tabletops arranged at a height that allow easy use for the setting of drinks or food thereon, while people stand therearound, allowing people to congregate around for collaboration and socialization.

In cases where outlets are placed into a housing, particularly a housing that is curved or non-flat, such as a pedestal for a table, there is a need to retain and position the outlets so that they can be properly presented through the non-flat surface. The electrical power cord needs to be secured to the pedestal.

What is needed in the art is a cost-effective power cord coupling that allows for the delivery of electrical power to electrical outlets contained in non-flat housings such as tubular columns.

### SUMMARY OF THE INVENTION

The present invention provides an electrical power coupling that is insertable into a tubular column.

The invention in one form is directed to an electrical power coupler for installation in a tower pedestal table, the tower pedestal table having a column extending up from a base. The electrical power coupler including a generally cylindrical shaped structural member that is insertable into an end of the column. There is at least one channel along a side of the structural member, and the at least one channel has an obstructed end. A power conduit extends through the structural member.

The invention in another form is directed to an electrical power coupler for installation in a column. The electrical power coupler including a generally cylindrical shaped structural member that is insertable into an end of the column. There is at least one channel along a side of the structural member, and the at least one channel has an obstructed end. A power conduit extends through the structural member.

An advantage of the present invention is that it both secures an electrical power cord to itself, it also is secured to a column into which it is inserted.

Another advantage of the present invention is that the electrical power coupling can be fitted into a tight constrained place, such as inside a tubular column.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an embodiment of a tower tray system having an embodiment of an electrical power coupling of the present invention therein;

FIG. 2 is a side view of the tower tray system of FIG. 1;

FIG. 3 is an exploded perspective view of an embodiment of the electrical power coupling of the present invention that is inserted into the tower tray system of FIGS. 1 and 2;

FIG. 4 is a perspective view of part of the base of the tower tray system of FIGS. 1 and 2 and is also shown in FIG. 3;

FIG. 5 is a perspective view of the electrical power coupling of the present invention that is insertable into the column of the tower tray system of FIGS. 1 and 2 and is also illustrated in FIG. 3; and

FIG. 6 is an exploded partially schematical view of the electrical power coupling of FIGS. 3 and 5, illustrating its positioning within the tower tray system of FIGS. 1 and 2 and how it relates to the electrical power receptacles.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

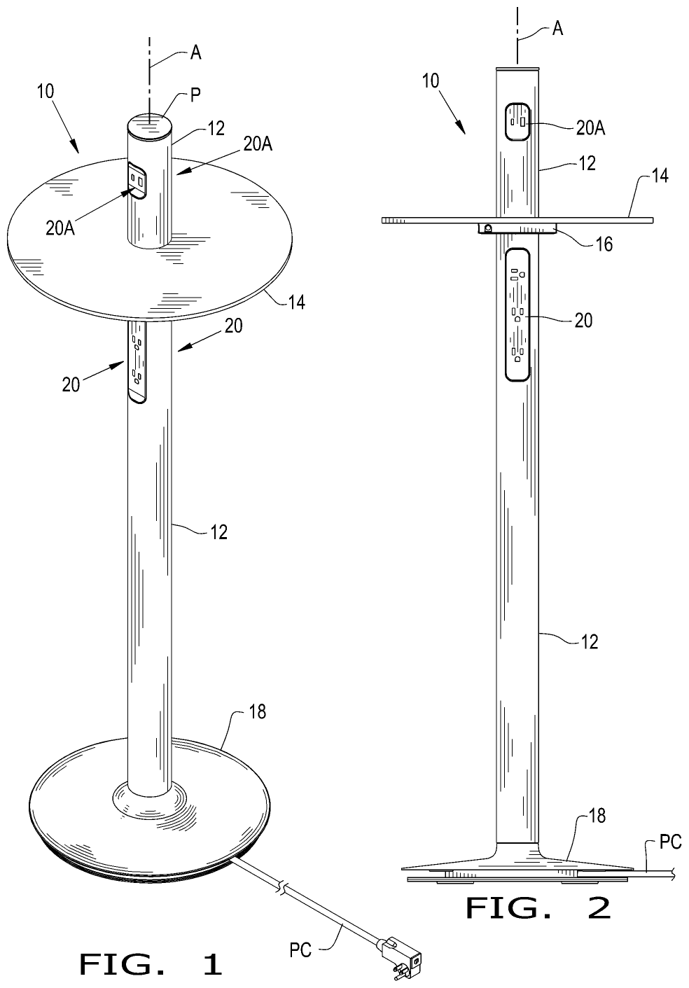

Referring now to the drawings, and more particularly to FIGS. 1 and 2, there is shown an embodiment of a tower system 10 including a column 12, a tray 14, a tray collar 16, a base 18, a set of outlets 20, and a set of outlets 20A. Tray collar 16 can also be referred to as a tray clamp 16. Tray column 12 may be a cylindrical tube 12 having electrical and data connections presented along the sides that are connected to electrical conductors that run therein. Tray 14 is illustrated as a disk-shaped tray 14, although other shapes are also contemplated. Tray 14 has an opening 24 though which column 12 extends. Tower system 10 is generally symmetrical along axis A in that outlets 20 and 20A are present on each side of column 12, although the positioning of the individual receptacles are offset in the longitudinal direction along axis A, so that the compact placement of the receptacles is possible in column 12.

Base 18 is arranged to set on a horizontal surface and provides support to column 12. Base 18 is formed to allow an electrical power cord PC to extend therefrom and have an opening through which electrical wiring can extend into column 12. Column 12 is depicted as a cylindrical tube 12, although other shapes are contemplated. Column 12 provides a wiring chase through which internal wiring is provided for the powering of outlets 20 and charging circuits that may be made available at outlets 20A. Slots are cut or formed along sides of column 12 to allow power fixtures such as outlets 20 and 20A that are presented to, and are available for, use by the user of tower tray system 10. Outlets 20 and 20A are presented on both sides of column 12, even though only one side is illustrated.

Outlets 20 and 20A have faceplates (additionally see FIG. 7) that conform with edges in the slots in column 12, so that edges of that slot are covered. The ends of the cover plates extend along the curve created by the curved ends of the slot, as seen in in FIG. 1, and the curve of the surface of column 12. The placing of outlets 20 and 20A along surfaces of column 12 are a mater of choice and can be at various positions along the length of column 12. Outlets 20 include electrical receptacles 20. A top plate P can be inserted at the top of column 12 to provide a finished look, and top plate P can be removed to provide access to the interior of column 12.

Tray collar 16 is constrained against column 12, with collar 16 being under tension, hence compressing collar 16 against column 12 to thereby prevent the movement of collar 16 relative to column 12. This allows tray 14 to rest upon tray collar 16.

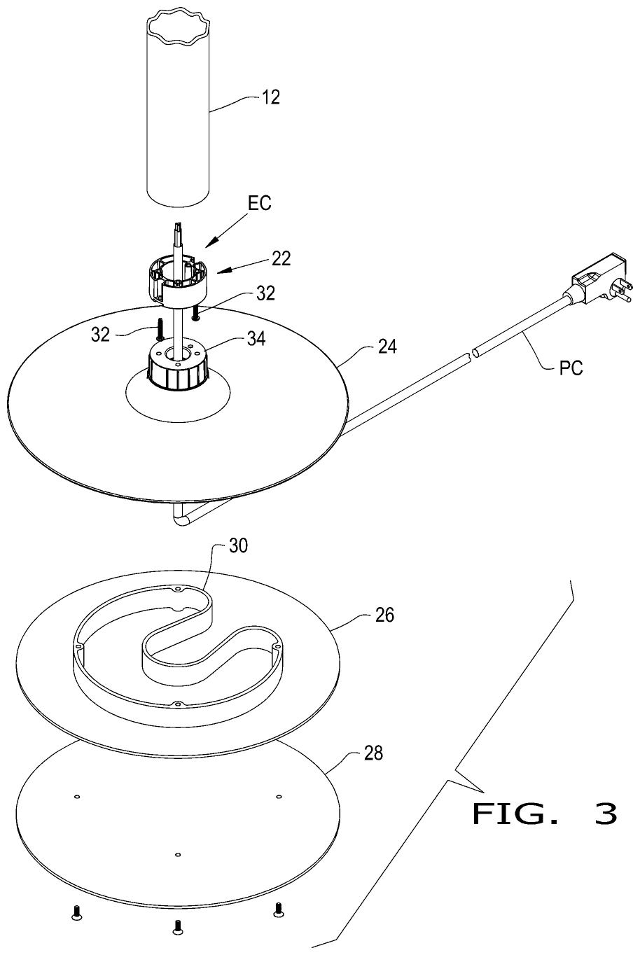

Now, additionally referring to FIG. 3, there is shown an exploded view of elements of base 18 and part of the electrical system within column 12, and particularly an electrical power coupling EC that includes a structural member 22. Elements of base 18 include an upper plate 24, a middle plate 26 and a lower plate 28. Middle plate 26 has a serpentine spacer 30 that spaces middle plate 26 from upper plate 24. Serpentine spacer 30 allows power cord PC to extend into the central portion of upper plate 24 and on into column 12 to supply electrical power to receptacles 20. As can be seen serpentine spacer 30 is spaced in from the outer edges of upper plate 24 and middle plate 26 so that power cord PC can be wrapped around the outer boundary of serpentine spacer 30 and be stored there largely within the outer space created by the height of serpentine spacer 30. It is also contemplated that serpentine spacer could extend from upper plate 24 rather than from middle plate 26. It is further contemplated that bottom plate 28 could be omitted, with middle plate 26 then serving as the portion of base 18 that would sit on a floor.

Electrical power coupling EC is shown being inserted into column 12 and is secured to column 12 by way of screws 32. Then upper plate 24 is at least partially inserted into column 12 and is secured to electrical power coupling EC with fasteners (not shown).

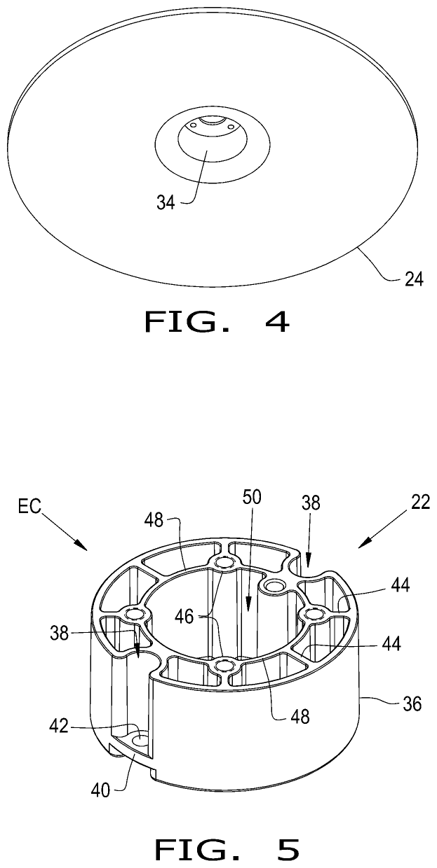

Now, additionally referring to FIG. 4, there is shown a bottom perspective view of upper plate 24. Upper plate 24 has a short truncated cylinder 34 with an opening therethrough so that power cord PC can extend through upper plate 24.

Now, additionally referring to FIG. 5, there is shown a perspective view of structural member 22 with a generally cylindrical outer wall 36, two channels 38, each truncated with an obstructed end 40 in channel 38. An opening 42 extends through obstructed end 40 allowing screws 32 to extend into a feature within column 12. Column 12 has either tabs, protrusions or an extending feature the orients channels 38 and stop the continued insertion of electrical power coupling EC into column 12 when the feature encounters obstructed end 40. Then screws 32 are secured to the feature thereby coupling structural member 22 to column 12.

Structural member 22 has a series of webs 44 that extend radially inward from outer wall 36. Some of webs 44 intersect with cylindrical webs 46 that have openings 48 that extend in an axial direction parallel to axis A. Structural member 22 also has a series of arcuate webs 48 that extend between cylindrical webs 46.

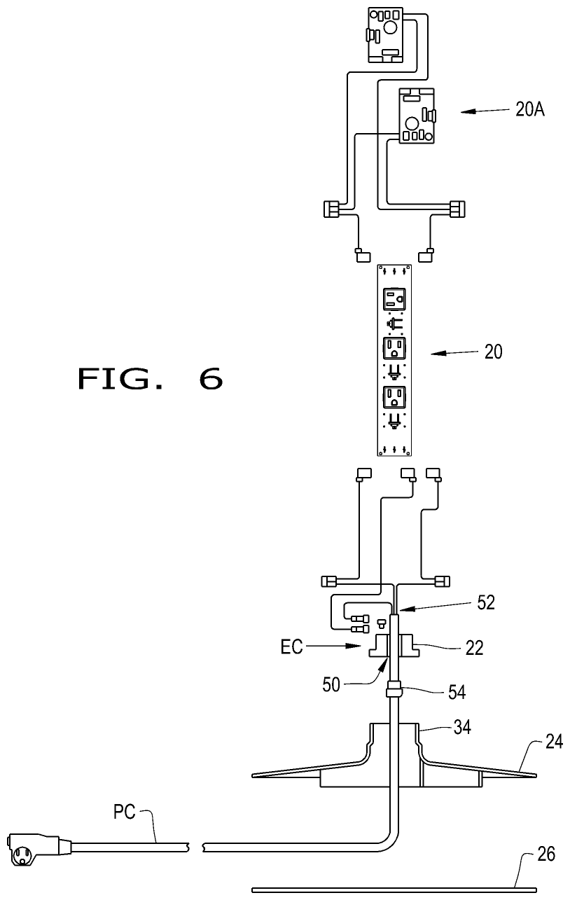

Now, additionally referring to FIG. 6 there is shown an electrical power set of conductors 52 extending through power conduit 50 of structural member 22. The electrical power set of conductors 52 are electrically coupled to electrical receptacles 20 further up the column, as schematically shown in FIG. 6, and as can be seen in FIGS. 1 and 2. Further up column 12 are power supplies 20A, which are also electrically connected to conductors 52, by way of the electrical connections within outlets 20, with power within column 12 being delivered by way of power cord PC. A securing element 54 secures power cord PC in power conduit 50 and thus to structural member 52, with power cord PC extending from the base of column 12, and base 18.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrical power coupler for installation in a tower pedestal table, the tower pedestal table having a column extending up from a base, the electrical power coupler comprising:
a generally cylindrical shaped structural member that is insertable into an end of the column;
at least one channel along a side of the structural member, the at least one channel having an obstructed end; and
a power conduit through the structural member.

2. The electrical power coupler of claim 1, wherein the obstructed end of the at least one channel limiting how far the structural member is inserted into the column.

3. The electrical power coupler of claim 2, wherein the at least one channel is a plurality of channels including a first channel and a second channel each with obstructed ends.

4. The electrical power coupler of claim 3, further comprising a plurality of fasteners that extend through the obstructed ends and engage the column to secure the structural member to the column.

5. The electrical power coupler of claim 1, further comprising an electrical power set of conductors extending through the power conduit, the electrical power set of conductors being coupled to electrical receptacles further up the column.

6. The electrical power coupler of claim 5, wherein the electrical power set of conductors being electrically connected to a power cord that extends from the tower pedestal table.

7. The electrical power coupler of claim 6, wherein the power cord extends from the base.

8. The electrical power coupler of claim 1, wherein the structural member has a series of webs that extend radially inward from an outer wall.

9. The electrical power coupler of claim 8, wherein some of the webs intersect with cylindrical webs that have openings that extend in an axial direction.

10. The electrical power coupler of claim 9, wherein the structural member has a series of arcuate webs that extend between the cylindrical webs.

11. An electrical power coupler for installation in a column, the electrical power coupler comprising:
a structural member that is insertable into an end of the column;
at least one channel along a side of the structural member, the at least one channel having an obstructed end; and
a power conduit through the structural member.

12. The electrical power coupler of claim 11, wherein the obstructed end of the at least one channel limiting how far the structural member is inserted into the column.

13. The electrical power coupler of claim 12, wherein the at least one channel is a plurality of channels including a first channel and a second channel each with obstructed ends.

14. The electrical power coupler of claim 13, further comprising a plurality of fasteners that extend through the obstructed ends and engage the column to secure the structural member to the column.

15. The electrical power coupler of claim 11, further comprising an electrical power set of conductors extending through the power conduit, the electrical power set of conductors being coupled to electrical receptacles further up the column.

16. The electrical power coupler of claim 15, wherein the electrical power set of conductors being electrically connected to a power cord that extends from the column.

17. The electrical power coupler of claim 16, wherein the power cord extends from a lower portion of the column.

18. The electrical power coupler of claim 11, wherein the structural member has a series of webs that extend radially inward from an outer generally cylindrical wall that is interrupted by the at least one channel.

19. The electrical power coupler of claim 18, wherein some of the webs intersect with cylindrical webs that have openings that extend in an axial direction.

20. The electrical power coupler of claim 19, wherein the structural member has a series of arcuate webs that extend between the cylindrical webs.
